(19) United States
(12) Patent Application Publication
(10) Pub. No.: US 2012/0281712 A1
(43) Pub. Date: Nov. 8, 2012

(54) TRANSMITTING-RECEIVING APPARATUSES AND METHODS FOR TRANSMITTING AND RECEIVING DATA

(75) Inventor: Harald EISELE, Wiesbaden (DE)

(73) Assignee: GM GLOBAL TECHNOLOGY OPERATIONS LLC, Detroit, MI (US)

(21) Appl. No.: 13/462,020

(22) Filed: May 2, 2012

(30) Foreign Application Priority Data
May 2, 2011 (DE) 10 2011 100 212.3

(51) Int. Cl. H04L 12/413

(52) U.S. Cl. 370/445

(57) ABSTRACT

A transmitting-receiving apparatus for a communication system for a vehicle is provided. The communication system also comprises a second transmitting-receiving apparatus. The apparatuses are connected via a bus. Messages from the transmitting-receiving apparatus to the second transmitting-receiving apparatus are transmitted by frames. Each frame comprises a first part. During the transmission of the first part, the one or both apparatuses determine whether there is a collision on the bus. Each frame also comprises a second part for transmitting useful data. The transmitting-receiving apparatus is adapted to transmit the first part of the frame via the bus at a first transmission frequency and the second part of the frame at a second transmission frequency. The second transmission frequency is higher than the first transmission frequency.

### CROSS-REFERENCE TO RELATED APPLICATION

This application claims priority to German Patent Application No. 10 2011 100 212.3, filed May 2, 2011, which is incorporated herein by reference in its entirety.

### TECHNICAL FIELD

The technical field relates to a transmitting-receiving apparatus as well as methods for transmitting and receiving data.

### BACKGROUND

In vehicles a plurality of communication protocols for local networks (Local Area Networks, LANs) are used. In particular, for example, the CAN (Controller Area Network) protocol is used. A CAN bus contains two lines to which a plurality of transmitting-receiving apparatuses are connected. Messages are transmitted from one participating transmitting-receiving apparatus to other transmitting-receiving apparatuses by transmitting frames via the bus. A frame contains at least one SOF (Start of Frame) bit, which indicates the start of the frame, a field with identification codes, and a field with data codes.

The CAN protocol is based on a so-called CSMA/CD principle. CSMA (Carrier Sense Multiple Access) means in this context that a plurality of subscribers can access the bus and thereby observe the status of the bus line. Observation of the bus line is used so that subscribers do not transmit when another subscriber having higher priority is transmitting at the same time.

CD (Collision Detect) means that subscribers detect collisions and avoid an incipient competitive situation by interrupting at least one transmission process. A subscriber that has interrupted its transmission then attempts to transmit again after the bus has become free again. This process is described as arbitration or arbitrating. If a collision of transmitted frames occurs, a decision is made as to which of the transmitters has priority. To this end, the signal levels on the bus lines are divided into “dominant” for high priority and “recessive” for low priority. If a dominant level and a recessive level are transmitted simultaneously, the resulting signal level on the bus line becomes dominant. Usually the logic value of a dominant level is zero, with the logic value of a recessive level being one. An SOF code is usually dominant whereas the codes of the subscribers differ from one another in the identification (ID) codes. Those subscribers which transmit the respective dominant levels in their ID codes prevail compared with those subscribers which transmit codes having a recessive level during this time. Collision detection takes time, with the result that the method is relatively slow compared with other methods.

It is at least one object to provide a transmitting-receiving apparatus with which frames can be transmitted more rapidly via the bus. In addition, it is another object to provide corresponding methods for transmitting and receiving data. In addition, other objects, desirable features and characteristics will become apparent from the subsequent summary and detailed description, and the appended claims, taken in conjunction with the accompanying drawings and this background.

### SUMMARY

A transmitting-receiving apparatus for a communication system of a vehicle is provided. The communication system comprises a plurality of transmitting-receiving apparatuses, which communicate with one another via a bus. The messages from one of the transmitting-receiving apparatuses are sent to another transmitting-receiving apparatus by means of frames. The frames each comprise one first part, during the transmission whereof at least one transmitting transmitting-receiving apparatus checks whether there is a collision on the bus. A second part of the frame is used for transmitting useful data. The transmitting-receiving apparatus is adapted to transmit the first part of the frame via the bus at a first transmission frequency and for transmitting the second part of the frame at a second transmission frequency. The second transmission frequency is higher than the first transmission frequency.

With these transmitting-receiving apparatuses, the useful data can be transmitted at a higher transmission frequency. The frame as a whole is therefore transmitted faster than conventionally. It is taken into account here that a collision check need not necessarily be made during the transmission of useful data. Consequently, data are present earlier in each case in the receiving transmitting-receiving apparatuses and can be accepted earlier. Thus, the time for the transmission of the bits during the second part of the frame can be shortened with the result that the entire time for transmission of the frame is shortened. Consequently, a higher data rate capacity, which is also designated as bus speed, can be achieved for data communication protocols which use so-called “carrier sense” methods for detection which transmit a plurality of network nodes independently.

An example of such a detection method is the CAN (Controller Area Network) data communication protocol. The CAN data communication protocol requires direct response from a receiver during the bit transmission in the arbitration time of messages and in acknowledgment slots of messages. As an example, in an exemplary embodiment, a shortened bit length is used outside the message section in order to increase the data throughput capacity of the communication protocol. For example, a reduced bit length is selected to be half as large as the bit length during the message sections in which a receiver should respond directly in order to enable bus arbitration and/or a message acknowledgment.

An appreciably higher data throughput is provided for the data communication protocol that uses so-called “carrier sense” methods for detecting whether another device is transmitting simultaneously or whether a message acknowledgment exists.

Typically it is not necessary to change the lower layer, which is also called physical layer, in order to achieve the appreciably higher data throughput. Merely changes in the data communication protocol are required.

The CAN protocol uses two different parts within a message. On the one hand, there are message parts of type 1 which require a response from other nodes within the respective bit slot. These are arbitrations and/or acknowledgments. The second message parts of type 2 do not require any response from other nodes within the respective bit slot. These are other parts of the CAN message. Message parts of type 1 generally require that data rates/the bit lengths be restricted to forward-return delay in the present communication protocol. This restriction is not necessary for message parts of type 2 since the simple delay is sufficient for the function there. It is proposed to divide the bit lengths into the two message parts so that technically unnecessary broadband restrictions in the messages are eliminated.

Transmitting-receiving apparatus is particularly suitable for communication systems that contain a wired bus and in which the transmitting-receiving apparatus is suitable for transmitting and receiving signals from the wired bus. Since the transmitted messages in the case of wired signals are not usually modified at higher frequencies, the receiver circuits or transmitter circuits can be adapted to the different transmission frequencies with relatively simple circuits without needing to vary demodulators, for example.

In one embodiment the frames each contain a third part, which follows the second part and which has at least one bit for transmitting an acknowledgment of receipt. The transmitting-receiving apparatus is thereby adapted to transmit the third part of the frame at the first transmission frequency. It is thus taken into account that longer run times must be taken into account for the transmission of an acknowledgment of receipt than for the transmission of useful data. Consequently, the higher second transmission frequency is only used when the simple transmission times determine the critical path. Consequently, the second transmission frequency can be designed for the simple transmission times and therefore set as high as possible.

In one embodiment the transmitting-receiving device contains a memory for storing a bit length for the first part of the frame and a bit length for the second part of the frame. The scanning time points in the particular transmitting-receiving apparatus are specified with the aid of this memory.

In one embodiment the difference between the bit length for the first part of the frame and the bit length for the second part of the frame is stored.

The memory of the transmitting-receiving apparatus can preferably be programmed from outside the transmitting-receiving apparatus via the bus. Thus, a communication system which is already installed, for example, in a vehicle can be changed if it is established that this frequently results in collisions on the bus and data are usually only transmitted in a delayed manner via the bus.

The transmitting-receiving apparatus, in an embodiment, contains a frequency generating apparatus to generate a base frequency, where the reciprocal of the first transmission frequency and the reciprocal of the second transmission frequency are each integral multiples of the reciprocal of the base frequency. The transmission frequencies are thereby quantized and they are derived from a common base frequency so that problems of synchronization when changing from the first transmission frequency to the second transmission frequency are avoided.

In one embodiment, the scanning time points for bits to be received by the bus are set in such a manner that the time interval between a scanning time point of a bit to be received and a respective end of this bit for the first part of the frame is equal to the time interval between a scanning time point of a bit to be received and a respective end of this bit for the second part of the frame. In this case, it is assumed that the time until a bit to be transmitted is present stably at the input of a received transmitting-receiving apparatus for the first part of the frame is longer than the corresponding time for the second part of the frame. It is therefore advantageous to specify the scanning time points in relation to the end of the bit.

The application relates to a vehicle having a communication system that for its part comprises a plurality of transmitting-receiving apparatuses as described above. The transmitting-receiving apparatuses are interconnected in this case via a wired bus. In such a vehicle the frames are transmitted faster than in conventional methods. Consequently, overall more frames can be transmitted per unit time.

A method for transmitting data via a wired bus of a communication system of a vehicle also is provided. The communication system comprises a plurality of transmitting-receiving apparatuses, which communicate with one another via the bus. Messages from one transmitting-receiving apparatus to another transmitting-receiving apparatus are transmitted by means of frames. The frames each comprise at least one first part, during the transmission whereof at least one transmitting transmitting-receiving apparatus checks whether there are collisions on the bus. A second part of the frame is adapted for transmitting useful data. In the method during transmission of the frame, the first part of the frame is transmitted via the bus at a first transmission frequency and the second part of the frame is transmitted at a second transmission frequency. The second transmission frequency in this case is higher than the first transmission frequency.

The method enables a faster overall transmission of the frame since the useful data are transmitted more rapidly than the data of the first part.

The frame preferably has a third part, which follows the second part and which has at least one bit for transmitting an acknowledgment of receipt, and the third part of the frame is transmitted at the first transmission frequency. It is thereby taken into account that longer run times between the subscribers should be assumed during the transmission of the acknowledgment of receipt.

In an embodiment, the method is based on the generation of a first base frequency, where the reciprocal of the first transmission frequency and the reciprocal of the second transmission frequency are each integral multiples of the reciprocal of the base frequency. Thus, as specified above, the risk of an incorrect synchronization between the transmission of the first part and the transmission of the second part of the frame is largely averted.

If the scanning time points for the data to be received are set in such a manner that the time interval between a scanning time point of a bit to be received and the respective end of this bit for the first part of the frame and the second part of the frame are equal, consideration is given to the fact that the bits are each present at the respective receivers after variously long times following commencement of transmission of the bit.

A method for receiving data via a wired bus of a communication system of a vehicle also is provided. The communication system comprises a plurality of transmitting-receiving apparatuses, which communicate with one another via the bus. In this case, messages from one transmitting-receiving apparatus to another transmitting-receiving apparatus are transmitted by means of frames and the frames each comprise at least one first part, during the transmission whereof at least one transmitting transmitting-receiving apparatus checks whether there is a collision on the bus. The second part of the frame is used for transmitting useful data. The first part of the frame is scanned via the bus at a first scanning frequency and the second part of the frame is scanned at a second scanning frequency. The second scanning frequency is greater than the first scanning frequency. This method enables the receipt of frames at a higher data transmission rate than in conventional methods in which the data transmission rates for the first part of the frame and for the second part of the frame are the same.

The methods for transmitting or receiving are each particularly suitable for wired buses since the transmission frequencies can be varied with these without major change in the high-frequency properties of the circuits.

It can be established that in conventional CSMA data transmission methods a bit length is typically selected which is greater than the sum of the round trip time in the transmission medium. Reliable collision detection is thereby possible but the data rate is perceptibly restricted. In some CSMA transmission methods, for example, in the CAN protocol, access to the transmission medium is regulated in the so-called arbitration field. Should a collision occur, this is then resolved at the end of the arbitration field. Thereafter, only one node continues the transmission of its message, e.g. it then transmits useful data. If a collision detection is not necessary in the area of the useful data, e.g. since possible collisions have previously be resolved in the arbitration field, then the round trip time is no longer the relevant limiting value for dimensioning the useful data bit length but merely the simple run time in the transmission medium.

This means that at the end of the arbitration field, the length of bits can be shortened by the amount of the simple run time in the transmission medium. A higher transmission rate is thereby made possible without this leading to errors or unrecognized collisions. This can, for example, be used usefully in the CAN data transmission systems now commonly used in automobiles. A higher data rate enables the implementation of other customer-relevant functions without needing to install more cable for this and without needing to change to more complex and more expensive data bus systems.

### DETAILED DESCRIPTION OF THE DRAWINGS

The various exemplary embodiments will hereinafter be described in conjunction with the following drawing figures, wherein like numerals denote like elements, and wherein:

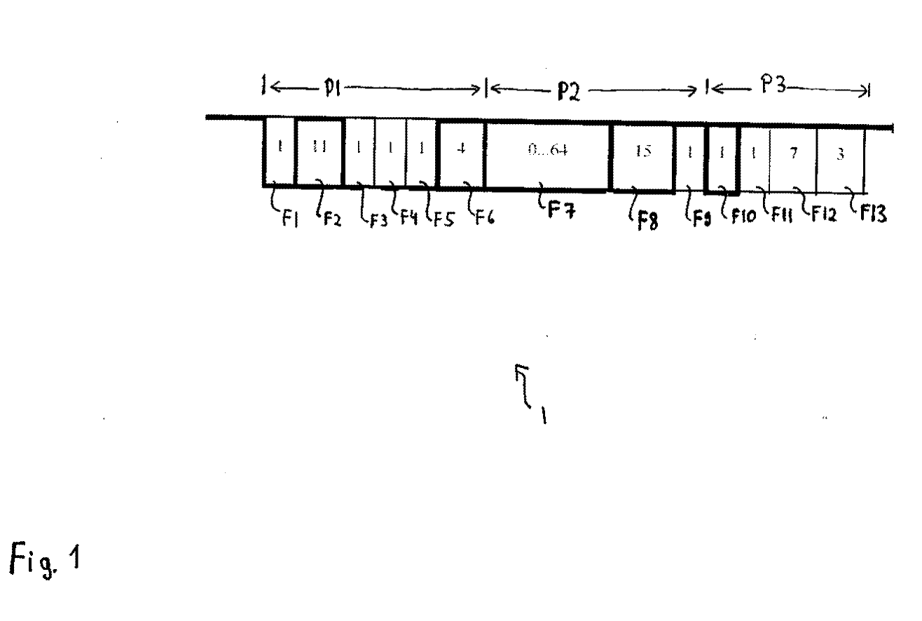

FIG. 1 shows a frame to be transmitted via a bus in accordance with an exemplary embodiment;

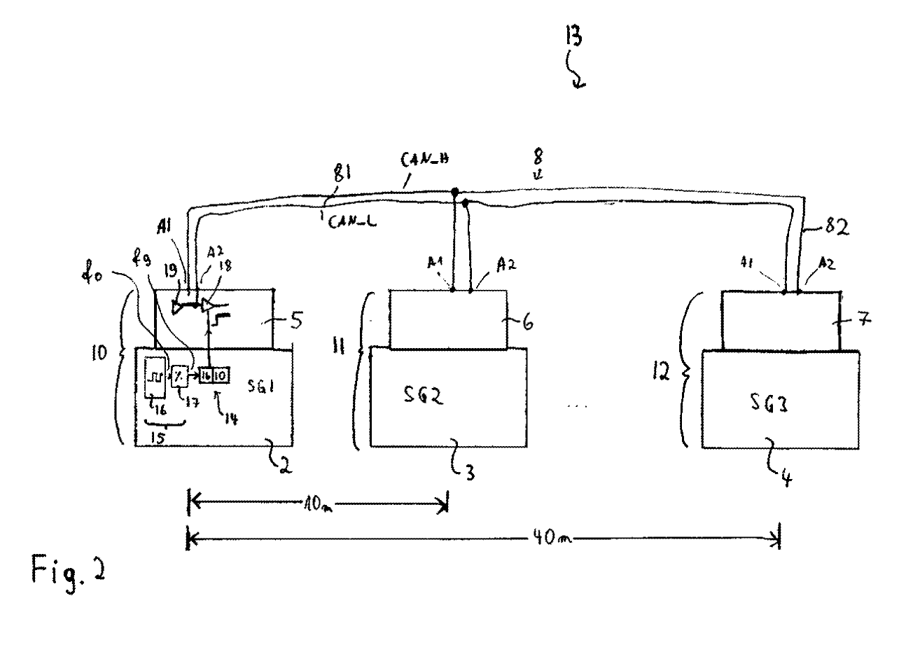

FIG. 2 shows the structure of a communication system with a plurality of subscribers in accordance with an exemplary embodiment; and

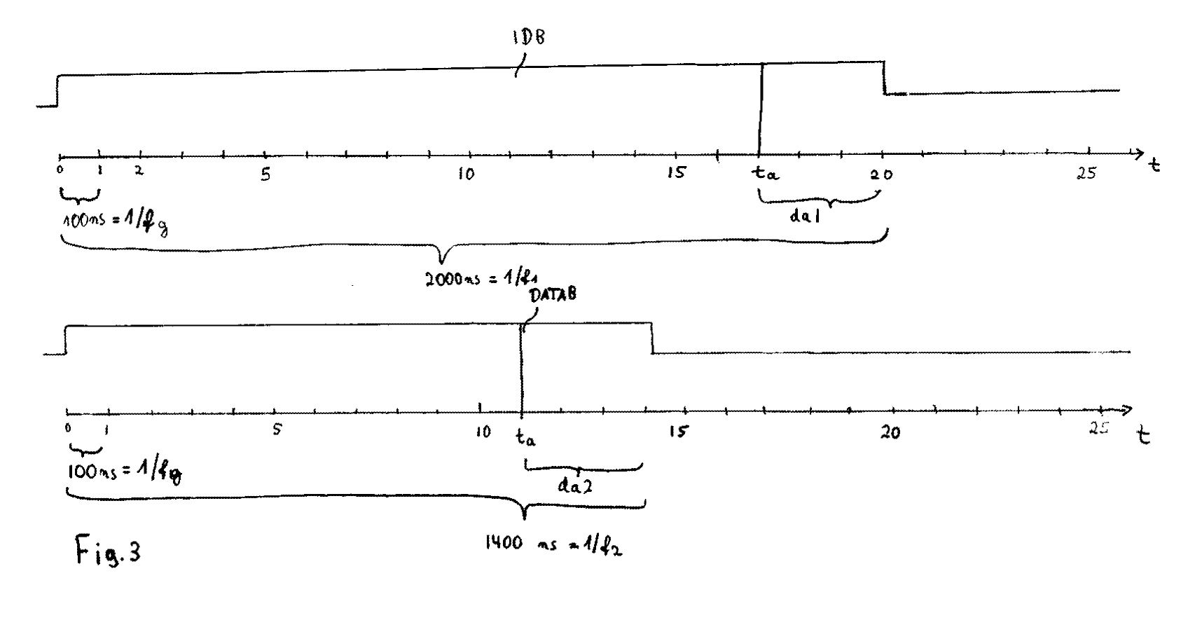

FIG. 3 shows the time sequence for the transmission of data in accordance with an exemplary embodiment.

### DETAILED DESCRIPTION

The following detailed description is merely exemplary in nature and is not intended to limit the application and uses of the various embodiments herein. Furthermore, there is no intention to be bound by any theory presented in the preceding background or the following detailed description.

FIG. 1 shows in a schematic view a frame to be transmitted via a bus. The frame is divided into the fields F1, F2, F3, F4, F5, F6, F7, F8, F9, F10, F11, F12, and F13, which can each also be designated as words. The frame starts with the first field F1, which contains a dominant bit, called “start of frame”. The following field F2 is the identifier field which contains 11 bits. With the aid of the identifier field F2 and the following field F3, that contains a so-called RTR (remote transmission request) bit, which together form the so-called arbitration field, the subscribers can identify whether they can send the frame or whether the sending of the frame should be interrupted since frames of other subscribers having higher priority are being sent simultaneously.

The field F3 is followed by a control field F4, which comprises the so-called “identify extension bit”. F5 is a reserved bit and the field F6 contains 4 bits, which specify the length of the data field. The data field F7 then follows, which contains up to 64 bits. This is then followed by the check sum field F8 with 15 bits and a recessive CRC delimiter bit contained in the field F9. The field F10 contains an acknowledgment bit and the field F11 contains an acknowledgment delimiter. This is followed by a 7-bit long field F12 which marks the end of the frame. This is finally followed by the so-called intermission F13 with 3 bits, which separates successive frames from one another.

It should be noted that especially for the arbitration field, which contains the fields F2 and F3, it is important that sufficient time is provided in order to detect whether another subscriber has also transmitted. In order to calculate the time required for the transmission, it is not sufficient to take into account the transmission time from one subscriber to the subscriber located at the greatest distance from the subscriber. It is additionally necessary to wait for the time until a signal from the most distant subscriber has been seen back to the first subscriber. Otherwise, it could not be detected whether there is a collision. The long run time should also be taken into account in fields F4 and fields F10 and F11. For example, in field F10 an acknowledgment signal is awaited from a receiving subscriber, where the transmitting subscriber awaits the acknowledgment signal during the time for the current bit provided for the field.

In other cases, only the time from a first subscriber to the other subscriber located at the greatest distance from the subscriber must be taken into account. This relates, for example, to the data field F7. The frame 1 is divided into three parts. The first part P1 contains the fields F1 to F6, the second part P2 contains the fields F7, F8, and F9, and the third part P3 contains the fields F10 to F13.

If collisions were to occur in the second part, for example, when transmitting useful data in the data field F7, the error status is not notified to the connected subscribers during the transmission of the same bit but a few bits later.

During the transmission of the frame, the bits pertaining to part 2 are transmitted at a higher frequency than those bits which pertain to parts P1 to P3. Thus, the overall time required for transmission of the frame 1 is shortened.

In a further embodiment not shown here, the fields F12 and F13 are not assigned to the third part but to a fourth part of the frame 1. The fourth part of the frame is then sent at the second transmission frequency that is at the higher frequency, which additionally shortens the overall transmission time for the frame.

FIG. 2 shows schematically a communication system 13 having three subscribers which communicate with one another via a wired bus 8, which contains two bus lines 81 and 82. The communication system 13 contains a first transmitting-receiving apparatus 10, a second transmitting-receiving apparatus 11, and a third transmitting-receiving apparatus 12.

The first transmitting-receiving apparatus 10 contains a first controller 2 and a first transceiver 5, which is directly connected to the first controller 2. The second transmitting-receiving apparatus 11 contains a second controller 3 and a second transceiver 6, which is directly connected to the second controller 3, and the third transmitting-receiving apparatus 12 contains a third controller 4 and a third transceiver 7, which is directly connected to the third controller 4.

The transceivers 5, 6, and 7 each have two connections A1 and A2, which are connected to the bus lines 81 or 82. Since this comprises a CAN bus, the bus lines 81 and 82 are also designated by CAN_H and CAN_L. The controllers 2, 3, and 4 each control the transceivers 5, 6, and 7 connected directly to them. The controllers 2, 3, 4 each receive frames via the bus lines 81 and 82 via their respective transceivers 5, 6, 7 or send frames to at least one of the other controllers 2, 3, and 4 via their respective transceivers 5, 6, 7 and the bus lines 81 and 82.

The first controller 2 and the first transceiver 5 are implemented within a device while the second controller 3 and the second CAN transceiver 6 are configured as another device. The third controller 4 and the third CAN transceiver 7 form a third device.

In an exemplary embodiment, the transmitting-receiving apparatuses 10, 11, 12 each contain two receiver circuits 18, two transmitter circuits 19, a frequency generating apparatus 15, and a memory 14. For the sake of clarity, these apparatuses are merely indicated in the first transmitting-receiving apparatus 10 and at the same time the receiver circuits 18 and transmitter circuits 19 only once in each case. In fact, the corresponding apparatuses are also located in the second and in the third transmitting-receiving apparatus 11 or 12.

The frequency generating apparatus 15 is provided in the controller 2 and contains an oscillator 16 and a frequency divider 17. The oscillator 16 generates an oscillator frequency “fo,” which is converted by the frequency divider 17 into a base frequency “fg.” This base frequency fg is output to the memory 14. This memory contains a first memory location 140 and a second memory location 141. A value for a scanning time point “ta” for the first part P1 is stored in the first memory location 140 and a value for the scanning time point “ta” during the second part P2 is stored in the second memory location 142. These values each give a multiple of the period duration, which is the same as the reciprocal of the base frequency fg. For example, the value for the scanning time point ta for the first part is 17 and the value for the scanning time point ta for the second part is 11 after the respective start of the bit.

The receiver circuit 18 is provided in the transceiver 5 and contains a clock input, whose triggering determines when the signal at the input of the receiver circuit 18 is switched to the output of the receiver circuit 18. This clock signal is provided by the memory 14, which provides for a signal change at the clock input of the receiver circuit 18 at the respective scanning time point ta.

In an embodiment, the line lengths between the controller 2 and the controller 3 are ten meters whereas the line lengths between the controller 2 and the third controller 4 are forty meters. In order to set the transmission rates, the run times between the subscribers must be taken into account. In this case, the critical path in each case is the path between the subscribers located at the greatest distance from one another. The most distant subscribers are the first controller 2 and the third controller 4.

The run time between these two controllers 2 and 4 is composed of the run time through the transceiver 5, the run time via the bus lines 81 and 82, and the run time through the third transceiver 7. If it is assumed that signals propagate through the bus lines 81 and 82 at ⅔ the speed of light, i.e. at 2×108 m/s, a delay of 200 ns (nanoseconds) is obtained over 40 m. The delays through the transceivers 5 and 7 are each assumed to be 205 ns. A total run time of 610 ns is thus obtained. For those signals for which a possible response of the receiver, for example, as a result of an arbitration or as a result of an acknowledgment bit must be awaited, the message is only returned after twice the run time. Twice the run time is therefore 1220 ns. In one example, it is assumed that the bits of parts P1 and P3 are each transmitted with a bit length of 2000 ns. The bit length is dimensioned as 2000 ns since the oscillators of the various transmitting-receiving apparatuses can deviate from one another and a reliable identification of the bits should also be ensured in the presence of deviations. This means that the data rate for bits of these parts P1 and P3 is 0.5 Mb/s.

FIG. 3 shows in two diagrams the time behavior for the transmission of bits for the first part P1 in the upper figure and for the second part in the lower figure. A bit IDB, that is part of the field F2, is transmitted via the bus 8. The time axis is divided into so-called quanta. One quantum has a length of 100 ns. This corresponds to the reciprocal of the base frequency fg. The base frequency is therefore 10 MHz.

The bit IDB is transmitted in the time interval between 0 and 20 quanta. In this time interval it is at a high level. The bit length of the bit IDB, like the bit lengths of all the other bits during the transmission of the first part P1, is 2000 ns. This is the same as the reciprocal of the first transmission frequency f1. The first transmission frequency f1 is therefore 0.5 MHz.

The scanning takes place at the time point 17 quanta after starting the bit IDB at time point 0 quanta. The interval between the scanning time point ta as far as the end of the IDB bit at 20 quanta is therefore da1=3 quanta. This means that the receiver circuit if the transmitting-receiving apparatus which is to receive the IDB bit receives the bit from the bus into an internal memory at the scanning time point ta and then the stored value is further processed as a valid received bit in the transmitting-receiving apparatus.

Since the scanning time points ta during transmission of the first part each lie at 17 quanta after starting the respective bit, the first scanning frequency fa1 is therefore also 0.5 MHz.

Since bits are transmitted during the second part without strictly needing to be checked for collision, for the transmission rate or for the scanning rate it is sufficient to allow for the simple run time between subscribers of the communication system. The bit time for the second part is calculated by subtracting the simple run time from the bit time for the first part. The bit length for the first part P1 is 2000 ns, the simple run time is 610 ns, which would give a bit time of 1390 ns. This bit time is rounded up to 1400 ns since the scanning time point should be a multiple of the reciprocal of the base frequency fg after starting the bit. The base frequency fg therefore ensures a quantization of the set bit times. The quantization has the advantage that the frequencies and scanning time points can be derived from the oscillator frequency by means of simple frequency dividers.

The bit time or the bit length for the data DATAB during the transmission of the second part is therefore 14 quanta. One quantum is in each case the same as during the transmission of the first part, 100 ns. This value is equal to the reciprocal of the base frequency fg. The scanning time point ta lies at 11 quanta after the start of the bit time. The interval da2 between the first scanning time point ta and the end of the bit that lies at 14 quanta after the start of the DATAB bit, is da2=3 quanta, which is the same as the corresponding time interval da1 for the first part P1. For the second part the scanning takes place 6 quanta earlier in relation to the respective start of the bits IDB and DATAB during the transmission of the first part or the second part.

This can be explained as follows. If a transmitter writes to the bus, twice the run time must be awaited in order to check whether another transmitter is also writing and a collision will result. Consequently, twice the run time must be taken into account. For the second part, on the other hand, only the simple run time must be awaited whereby the scanning can take place earlier. Overall a shorter bit length or bit time is obtained for the second part than for the first part.

The second transmission frequency, which is the same as the second scanning frequency, is 0.714 MHz, which is equal to the reciprocal of 1400 ns. It is assumed that the field F2 is 11 bits long whereas the field for the data transmission F7 contains 8 bytes of data plus four so-called stop bits. In addition, 15 bits for the field F8 and one bit for the field F9 are added in the second part. Consequently 84 data are transmitted with the second part P2. The total frame 1 has a length of 115 bits. If the frame were transmitted completely at a frequency of 0.5 MHz, a frame transmission time of 230 μs and a data rate of 0.5 Mbit/s would be obtained.

As a result of the faster transmission of the second part P2, the frame transmission time is now (115−84)·2 μs+84·1.4 μs+117.6 μs=179.6 μs. The data rate is now 115 bit/179.6 μs=0.64 Mb/s. Consequently a 28% higher data rate is achieved compared with conventional methods with constant transmission data rate.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A transmitting-receiving apparatus for a communication system for a vehicle, wherein the communication system comprises a second transmitting-receiving apparatus, wherein the transmitting-receiving apparatus is connected to the second transmitting-receiving apparatus via a bus, wherein messages from the transmitting-receiving apparatus to the second transmitting-receiving apparatus are transmitted by frames, wherein each frame comprises:
a first part, during a transmission of which the transmitting-receiving apparatus and/or the second transmitting-receiving apparatus determines whether there is a collision on the bus; and
a second part for transmitting useful data,
wherein the transmitting-receiving apparatus is adapted to transmit the first part of the frame via the bus at a first transmission frequency and for transmitting the second part of the frame at a second transmission frequency, wherein the second transmission frequency is higher than the first transmission frequency.

2. The transmitting-receiving apparatus according to claim 1, wherein the frames each have a third part that follows the second part and that has at least one bit for transmitting an acknowledgment of receipt, and wherein the transmitting-receiving apparatus is adapted to transmit the third part of the frame at the first transmission frequency.

3. The transmitting-receiving apparatus according to claim 1, wherein the transmitting-receiving apparatus has a memory for storing a bit length for the first part of the frame and a bit length for the second part of the frame.

4. The transmitting-receiving apparatus according to claim 3, wherein the memory is programmed from outside a respective transmitting-receiving apparatus via the bus.

5. The transmitting-receiving apparatus according to claim 1, wherein the transmitting-receiving apparatus is a frequency generating apparatus adapted to generate a base frequency, wherein a reciprocal of the first transmission frequency and a reciprocal of the second transmission frequency are each integral multiples of a reciprocal of the base frequency.

6. The transmitting-receiving apparatus according to claim 1, wherein, in the transmitting-receiving apparatus, scanning time points for bits to be received by the bus are set such that a time interval between a scanning time point of a bit to be received and a respective end of the bit for the first part of the frame is equal to a time interval between a scanning time point of a bit to be received and a respective end of the bit for the second part of the frame.

7. The transmitting-receiving apparatus according to claim 1, wherein the transmitting-receiving apparatus is configured to receive and transmit signals from a wired bus.

8. A vehicle having a communication system that comprises first and second transmitting-receiving apparatuses, wherein the first and second transmitting-receiving apparatuses are interconnected via a wired bus, wherein messages from the first transmitting-receiving apparatus to the second transmitting-receiving apparatus are transmitted by frames, wherein each frame comprises:
a first part, during a transmission of which the first transmitting-receiving apparatus and/or the second transmitting-receiving apparatus determines whether there is a collision on the wired bus; and
a second part for transmitting useful data,
wherein the first and second transmitting-receiving apparatuses are adapted to transmit the first part of the frame via the wired bus at a first transmission frequency and for transmitting the second part of the frame at a second transmission frequency, wherein the second transmission frequency is higher than the first transmission frequency.

9. A method for transmitting data via a bus of a communication system of a vehicle, wherein the communication system comprises a plurality of transmitting-receiving apparatuses that communicate with one another via the bus, wherein messages from one of the plurality of transmitting-receiving apparatuses to another of the plurality of transmitting-receiving apparatuses are transmitted by frames, wherein the frames each comprise:
a first part, during a transmission of which a transmitting transmitting-receiving apparatus checks whether there is a collision on the bus; and
a second part for transmitting useful data,
the method comprising the steps of:
transmitting the first part of the frame via the bus at a first transmission frequency during transmission of the frame; and
transmitting the second part of the frame at a second transmission frequency,
wherein the second transmission frequency is higher than the first transmission frequency.

10. The method according to claim 9, wherein the frames each have a third part that follows the second part and that has a bit for transmitting an acknowledgment of receipt, and wherein the method further comprises transmitting the third part of the frame at the first transmission frequency.

11. The method according to claim 9, further comprising generating a base frequency, wherein a reciprocal of the first transmission frequency and a reciprocal of the second transmission frequency are each integral multiples of a reciprocal of the base frequency.

12. A method for receiving data via a bus of a communication system of a vehicle, wherein the communication system comprises a plurality of transmitting-receiving apparatuses that communicate with one another via the bus, wherein messages from one of the plurality of transmitting-receiving apparatuses to another of the plurality of transmitting-receiving apparatuses are transmitted by frames, wherein the frames each comprise:
a first part, during a transmission of which a transmitting transmitting-receiving apparatus checks whether there is a collision on the bus; and
a second part for transmitting useful data,
the method comprising the steps of:
scanning the first part of the frame via the bus at a first scanning frequency; and
scanning the second part of the frame at a second scanning frequency, wherein the second scanning frequency is greater than the first scanning frequency.

13. The method according to claim 12, wherein the steps of scanning comprise setting scanning time points for bits to be received by the bus such that a time interval between a scanning time point of a bit to be received and a respective end of the bit (IDB) for the first part of the frame is equal to a time interval between a scanning time point of a bit to be received and a respective end of the bit for the second part of the frame.

14. The method according to claim 12, wherein in the plurality of transmitting-receiving apparatuses the frames each have a third part that follows the second part and that has at least one bit for transmitting an acknowledgment of receipt, and further comprising scanning the third part of the frame at the first scanning frequency.

15. The method according to claim 12, wherein the steps of scanning are performed via a wired bus.
